(19) United States
(12) Patent Application Publication
(10) Pub. No.: US 2011/0191662 A1
(43) Pub. Date: Aug. 4, 2011

(54) TRAVEL GUIDES FORMED BY AGGREGATION OF LOCATION-AWARE CONTENT FROM MULTIPLE PUBLISHERS THROUGH A UNIFIED INTERFACE

(76) Inventors: David Crawford Poteet, II, Blacksburg, VA (US); Melissa Carol Beaver, Blacksburg, VA (US); John Houston Williams, Christiansburg, VA (US)

(21) Appl. No.: 13/016,162

(22) Filed: Jan. 28, 2011

Related U.S. Application Data
(60) Provisional application No. 61/299,676, filed on Jan. 29, 2010.

(51) Int. Cl. G06F 17/00

(52) U.S. Cl. 715/202

(57) ABSTRACT

The present invention relates to the field of publishing and distributing information on a network. More particularly, the present invention relates to systems, methods, and devices for identifying multiple published entities each having electronic-based content of interest for a user, selecting portions of the e-content based on user preferences, aggregating the portions of e-content into a virtual compilation of e-content (e.g., virtual book) in a manner such that the portions of e-content appear to originate from the compilation and not the original source. The present invention is particularly advantageous in the travel guide industry where now portions of several larger travel guides can be aggregated together to provide mobile device users information tailored to a mobile device user's actual, exact, approximate, or anticipated location and optionally further refined in combination with the user's personal preferences. Even further, one of the key business implications of the aggregation scheme is that a publisher can take an existing work and divide it down into a set of smaller guides, even with some overlaps in content. Then the publisher can market those smaller guides at a lower price than the single complete guide to generate higher revenues than with publishing the indivisible discrete content alone (original complete travel guide).

### CROSS-REFERENCE TO RELATED APPLICATIONS

This application claims priority to and the benefit of the filing date of U.S. Provisional Application No. 61/299,676, filed Jan. 29, 2010, the disclosure of which is hereby incorporated by reference herein in its entirety.

### BACKGROUND OF THE INVENTION

1. Field of the Invention

The present invention relates to the field of publishing and distributing information on a network. More particularly, the present invention relates to systems, methods, and devices for identifying multiple published entities each having electronic-based content of interest for a user, selecting portions of the e-content based on user preferences, aggregating the portions of e-content into a virtual compilation of e-content (e.g., virtual book) in a manner such that the portions of e-content appear to originate from the compilation.

2. Description of the Related Art

Traditional travel guides are books or their direct electronic book (e-book) equivalent composed of many sections that describe their subject matter in a linear manner. Indices or table of contents help the user to navigate quickly to specific topics that are then read in a linear, page by page manner. The guides are not location aware and thus the content or indices and table of content remain the same regardless of where the guide is used. The user then has to manually ignore content that is not applicable because it describes something that is physically elsewhere and thus is of no immediate interest.

Additionally, travel guides do not necessarily contain all the information that the user wants. For example, the user may have a hiking guide and a lodging guide, which together must be used to meet the user's total needs. A single guide that meets a user's total needs will either be extremely large to cater for all the needs of all users, and/or will be extremely expensive as it will be uniquely tailored for each and every type of person.

What is needed are methods, systems, and devices for providing information to a user by selecting, collecting, and aggregating fragments of electronic-based information from multiple larger compilations and re-grouping the fragments into bundles of information tailored to relate to a specific user's needs and location, and presenting the information to the user through a user interface optionally capable of navigating the information in a non-linear manner.

### SUMMARY OF THE INVENTION

The present invention addresses the above-described issues by providing methods, apparatuses, and articles for aggregating location aware content from multiple sources and presenting the information to a user through a single unified user interface. The aggregation enables multiple published content sources to be combined into an apparent single source of information, and the location awareness filters the potentially large volume of aggregated data into a manageable subset for the user to select from.

It is important to note at the outset that e-travel guide type publications are one of the many downstream products that can benefit from the invention. Accordingly, embodiments of the invention are equally applicable to any method, system, or device for collecting, organizing, and/or presenting electronic content to a consumer or user regardless of the subject matter or use in which such content may typically be used.

Embodiments provide systems, methods, and devices for identifying published entities having electronic-based content (e-content) of interest, selecting all or portions of the published e-content, and aggregating the e-content into a discrete publishable entity, such that the portions of e-content appear to originate from the re-grouped compilation rather than from the original published source(s). The compilations or aggregations are optionally navigable by a user in a linear or non-linear manner.

Embodiments of the invention provide for the creation of a data format that enables collection of location aware multimedia fragments into a publishable entity such that the published entity consists of a set of location aware multimedia fragments. For example, the invention includes a location-aware multimedia fragment formatted for collection and aggregation with other common format location-aware multimedia fragments into a publishable entity composed of a set of the collected and aggregated fragments.

Further provided by embodiments of the present invention is the creation of one or more applications (e.g., software, methods, and/or systems) capable of performing one or more of the following: 1) enabling the collection and management of a variety of published entities, whether in whole or in part, 2) establishing the user's current or apparent location, and 3) presenting all multimedia fragments from all published entities that lie within a given distance from the established location through a unified user interface.

More particularly, the present invention provides for a system for aggregating information into a publishable entity comprising: one or more storage media comprising discrete groupings or sub-groupings of electronic content composed of one or more multimedia fragments (e-fragments) with location-aware tags and capable of being divisible from the discrete groupings or sub-groupings; a network operably connecting the e-fragment storage media with a mobile device for enabling communication between the mobile device and the e-fragments; and a mobile device with a storage medium and operably configured with a processor, software, and hardware for a) determining its location, b) communicating the location to the location-aware e-fragments, c) selecting and receiving data as one or more of the discrete groupings, discrete sub-groupings, or e-fragments, d) storing the data on the mobile device storage medium, e) further selecting e-fragments from the data and aggregating the selected e-fragments into a publishable entity, and f) presenting the publishable entity to a user of the mobile device as a virtual unified source.

Benefits of such systems, methods, devices, and applications are that the end-product publishable entity appears to the user of the mobile device as if it were the original source of the information, without the user knowing or being made aware that the content is based on pieces of content originating from another source or other multiple sources. In this way, sections of the end-product publishable entity can be navigated by the user randomly and without moving linearly (page-by-page) through the entity. Optionally, the methods, systems, and devices of embodiments of the invention are capable of collecting, aggregating, and re-aggregating the information multiple times in accordance with different user preferences or different locations of the mobile device.

Methods for providing location-aware data to a user are also included within the scope of the invention, where such methods comprise: a) identifying a location of a user's mobile device; b) identifying sites located within a selected distance of the location of the mobile device; c) identifying site-related information relating to the sites and contained in one or more location-aware multimedia fragments of one or more electronically published entity, wherein each multimedia fragment is configured in one common data format; d) collecting the published entities and multimedia fragments thereof; e) selecting and segregating from the published entities only the site-related information; f) aggregating only the selected and segregated site-related information into a compilation of site-related multimedia fragments; and g) presenting the compilation of site-related multimedia fragments as a virtual discrete publishable entity for display on the mobile device using a unified user interface.

Any of the device, system, application, or method embodiments disclosed herein are capable of further refinement of the presented information, data, or material according to a user's personal preferences. For example, the sites of interest and corresponding information can be identified according to user personal preference parameters accounted for in the methods, systems, devices, and applications of the invention. Personal preferences can include types of sites (e.g., limited to museums and monuments but not including parks), types of service providers (e.g., limited to restaurants but not including hotels), and types of emergency providers (e.g., hospitals and police, but not fire), and so on to name a few.

Methods, systems, and devices according to the invention can be operably configured to provide for local storage of the published entities or portions thereof on an electronic device, such as a hand-held mobile device. In embodiments, collecting of the multimedia fragments for presentation on the mobile device can optionally further comprise storing all or part of the published entities locally on the mobile device for off-line presentation of the information to the user of the mobile device. The storage location can also be a non-local storage device operably connected with the mobile device, whereby the mobile device can communicate directly or indirectly with the non-local storage device to obtain the information.

Preferably, methods, systems, and devices in accordance with embodiments of the invention are operably configured to provide an electronic device for accessing the published entities through some means of a direct or indirect data network. Systems and methods in accordance with the present invention can include communications means for identifying and collecting information over a direct or indirect data network.

Embodiments of the invention can be operably configured to provide for the inclusion of electronic devices capable of autonomously determining the exact or approximate location of the device by way of global positioning systems (GPS), cellular positioning, etc. Establishment of the exact or approximate location of the electronic device can also be achieved through user input or by connecting the device with another system capable of determining a location of the device.

Even further, the present invention includes methods of publishing electronic content comprising publishing, on a computer-based network, a set of multiple electronic multimedia fragments as a single acquirable compilation, wherein the compilation is operably configured for dissection into separately acquirable subsets of the multimedia fragments. Such compilations can be prepared as travel guides with the compilation subsets being micro-guides, and can alternatively or additionally include or encompass promotional, marketing, and other advertising material; as well as statistical information about various regions; directory information (such as email listings, cell phone and telephone listings, physical address information, etc.); service provider information; affiliation information (such as groups and associations connecting a user to a specific location), and so on to satisfy any user-directed need for information related to and/or located in and/or concerning a particular geographical area or a region of interest within a particular area. Optionally, in such configurations each multimedia fragment is configured in one common data format for providing for electronic re-grouping of the multimedia fragments.

Systems, methods, and devices of embodiments of the invention can be configured to be adapted to accommodate one or more various channels of distribution for the e-content fragments and compilations. More particularly, the content can be distributed directly to users themselves through interfaces which allow for direct purchase by the user of specific content the user desires. Alternatively, the content can be distributed using marketing organizations as the gate keepers to allow access to the desired information hosted by it or another party or provider. In such a scenario, the marketing organization can purchase or license access to the information, then provide subscription-based purchasing or free access to the information to the users. Accordingly, the embodiments described in this application can be modified to achieve any possible purchasing arrangement available.

The systems, applications, devices, and methods of embodiments of the invention are particularly useful in the context of travel by providing location aware content tailored to a mobile device user's preferences and including only subject matter relevant to the user's preferences and about sites of interest within a certain distance from the user at a particular time.

One of the key business implications of the aggregation scheme is that a publisher can take an existing work and divide it down into a set of smaller guides, even with some overlaps in content. Then the publisher can market those smaller guides at a lower price than the single complete guide. Higher publishing revenues are capable with the present invention in that sales could now be made where previously no potential for a sale existed. For example, people may be willing to pay $5 for something they want rather than paying nothing at all when the only choice was to pay $25 for mostly unwanted content. Even further, revenues can be increased if the price point of the micro-guides is set such that the sum of micro-guide purchases is greater than the single guide purchase. With the present invention, publishers are equipped with the ability to create guides, or compilations of content, that are more in depth, comprehensive, and tailored to a more narrow range of subject matter than a single guide attempting to satisfy most of the people most of the time by providing only a cursory review of a broader range of subjects.

These and other aspects of the present invention will be more apparent from the following description. The features and advantages of the present invention will be apparent to those skilled in the art. While numerous changes may be made by those skilled in the art, such changes are within the spirit of the invention.

### BRIEF DESCRIPTION OF THE DRAWINGS

FIG. 1 is a schematic diagram illustrating a user at the center of a circle of interest with various surrounding points of interest.

FIG. 2 is a schematic diagram illustrating a traditional approach to providing information about several topics segregated into several discrete, fixed books.

FIG. 3 is schematic diagram illustrating a traditional approach to providing information about several topics segregated into several discrete, fixed electronic books.

FIG. 4 is a schematic diagram illustrating an embodiment of the present invention that uses a single application to combine location aware material from several sources.

FIG. 5 is a schematic diagram illustrating an embodiment of the present invention that uses a single application to combine location aware material from several sources removing overlaps of content from within these sources.

FIG. 6 is a schematic diagram illustrating variations of embodiments of the present invention for aggregating desired data from several sources.

FIG. 7 is a schematic diagram illustrating another feature of embodiments of the present invention, namely, setting parameters for a search to control the number of results.

FIG. 8 is a schematic diagram representing how information can be collected and aggregated using embodiments of the invention to reduce the amount of information collected and aggregate the information from one or more sources in part or in whole.

FIG. 9 is a schematic diagram showing how information is collected when the user changes location and the distance parameter remains the same as in FIG. 8.

FIG. 10 is a schematic diagram showing how information is collected when the user changes location and the distance parameter remains the same as in FIG. 9.

FIG. 11 is a schematic diagram showing embodiments of the invention involving acquisition of location aware multimedia content from multiple publishers and storage of the content on a computer-readable storage medium.

FIG. 12 is a schematic diagram showing embodiments of the invention that aggregate location-aware multimedia content, filter the set of content by mobile device location and user area of interest, further filter that set by user preferences, and present content to a user.

FIG. 13 is a flowchart showing a representative process that may be used with embodiments of the invention for determining a location to use for content filtering.

FIG. 14 is a flowchart showing a representative process that may be used with embodiments of the invention for determining the area of interest to use for content filtering.

FIG. 15 is a flowchart showing a representative process that may be used with embodiments of the invention for determining user preference(s) for content filtering.

FIG. 16 is a flowchart showing a representative process that may be used with embodiments of the invention for aggregating all multimedia content, filtering by location and area of interest, and further filtering by user preference to produce a manageable set of content.

FIG. 17 is a flowchart showing a representative process that may be used with embodiments of the invention for presenting a preference and/or location filtered aggregate.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

It is noted that in the examples and description provided in this application, various modifications can be made and are also intended to be within the scope of the invention. For example, the described methods can be practiced using one or more of the method steps described, and in any order. Further, method steps of one method may be interchanged and/or combined with the steps of other methods described and/or with method steps known to those of ordinary skill in the art. Likewise, the features and configurations for particular devices and/or formats described in this application may be omitted, interchanged, and/or combined with other features described or known to those of ordinary skill in the art. Even further, devices and systems of the invention are not limited to the specific configurations described herein and include any configuration capable of performing the methods described in this application.

A data format is created to enable fragments of location aware multimedia to be collected and published in a manner similar to traditional travel guides. An application is created to combine one or more instances of the data format and to present the unified set of location aware multimedia fragments through a unified user interface implemented on an electronic device such as, but not limited to, a mobile phone, computer, personal digital assistant (PDA), Global Positioning System (GPS) device, or some other similar electronic device. Acceptable data structures include XML-based data formats.

The data format or structure can be expressed as a location-aware multimedia fragment, optionally XML-based, stored on a machine-readable medium, wherein the data is formatted for collection and aggregation with other common-format location-aware multimedia fragments into a publishable entity composed of a set of the collected and aggregated fragments.

Instances of the data format are synonymous to traditional travel guides. One or more instances of the data format may be acquired by the user from various sources and downloaded or copied to the electronic device through any form of a data network or data connection. The application does not require the electronic device to be attached to the data network or data connection to function, as it is able to function autonomously with the instances of the data format existing on the electronic device.

The application may use exact, user supplied, or approximate location information to only present information from the unified set of location aware multimedia fragments that lies within a certain distance from the location defined to the application, with the distance being defined directly or indirectly by the user. As the location supplied to the application changes, the application changes the information presented on the screen to correspond to the new location.

The user is able to define topics of interest to the application to further filter down to the location aware multimedia fragments to match the user's interest and current location, within the distance of interest defined by the user.

The invention creates a data format and application that enables the user to combine multiple travel guides described according to the data format into an apparent single travel guide that is created by the user by acquiring different content titles such that the user has all information available through a single unified user interface without the necessity to switch between different content titles as is necessary with traditional travel guides.

Further, although the invention is demonstrated below with respect to travel guides as a particular example, the system, device, application, and method embodiments in accordance with the invention are equally applicable in other arenas in which any information is distributed to potential consumers or users. For example, the invention is not restricted to use in the travel segment and can be applied in any publishing market where a potential acquirer of content desires customizable content, such as with respect to cookbooks, sales brochures, etc.

A particular example might include making available electronic-format sales brochures for multiple retail locations, whereby a potential purchaser of product at a retail location could be alerted that a certain product (determined by user input or personal preference settings) is available for a certain price at several different retail providers. As the user of the mobile device enters a vicinity in which these stores are located, the mobile device can identify, segregate, and collect the relevant information from the e-brochures of each retail provider and present the collected information to the mobile device user as a virtual compilation. Even more particularly, a user equipped with a mobile device of the invention could set the device to locate all stores within a given area selling a particular brand and type of running shoe. When the user is out shopping, the mobile device receives an alert that the running shoes are available at Target, Sears, Belk, JC Penny, and Walmart. The information is located in e-brochures provided by each of the retail providers and can be extracted from those individual brochures and aggregated into a single virtual brochure, including only information on the sneakers from only those locations, for the user to then navigate the condensed virtual brochure to decide where to make the purchase.

### DESCRIPTION OF THE PREFERRED EMBODIMENT

A data format is created that integrates location coordinates with multimedia content that includes, but is not limited to text, pictures, video, audio and hyperlinks to other content to name a few. This data format enables the collection of multiple items of information, about one or more locations, and originating from one or more sources to be stored within one data file. This data file may be transmitted to a so called smart phone, or other mobile device with capabilities of presenting multimedia content, through any number of networks including, but not limited to, cellular data networks, wired and wireless computer networks, or through a data cable connected to a computer system that itself contains the data file or a connection to a computer network on which the data file exists.

Optionally, the mobile device is able to store multiple and distinct guides, each of which relates to one or more locations of interest (e.g., geographical sites), with one or more pieces of multimedia information about each location. The guides can be stored in one or more separate data files or databases on the mobile device or in another storage location in communication with the mobile device. The data files can be supplied by different suppliers—the user of the invention is able to obtain different guides from different sources and collect them at least upon a mobile device that contains the invention's application.

The user may also build a library of such data files on some form of computer system or computer storage system, including, but not limited to, an online service that enables the user to select, obtain, organize and manage a collection of guides published in the data format, and to subsequently copy them onto a mobile device, along with an embodiment of the invention's application purposed for the specific mobile's capabilities and operating environment to present the aggregated location aware data as described below according to the data's multimedia type.

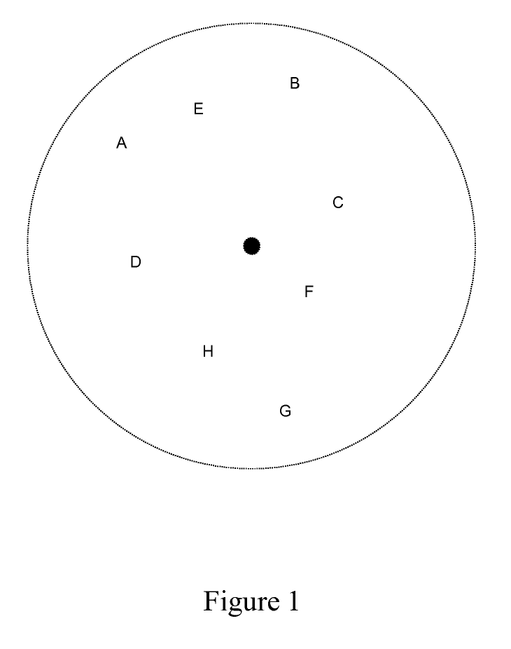

FIG. 1 is a schematic diagram of an embodiment of systems of the present invention. In FIG. 1, a user's location is represented as the center of the circle of interest (here, a black dot). The circle of interest represents the user's range of interest. Although drawn and described as a circle for simplicity the range of interest may have different distances from the user in different directions, indeed any distance in any direction can be included in the user's range of interest. Eight example points of interest within the user's range of interest are provided as illustrated in the diagram and labeled ‘A’ through to ‘H’. The numbers of points of interest could be greater than or less than the illustrative eight points of FIG. 1, and any number of points of interest can be included within the user's range of interest.

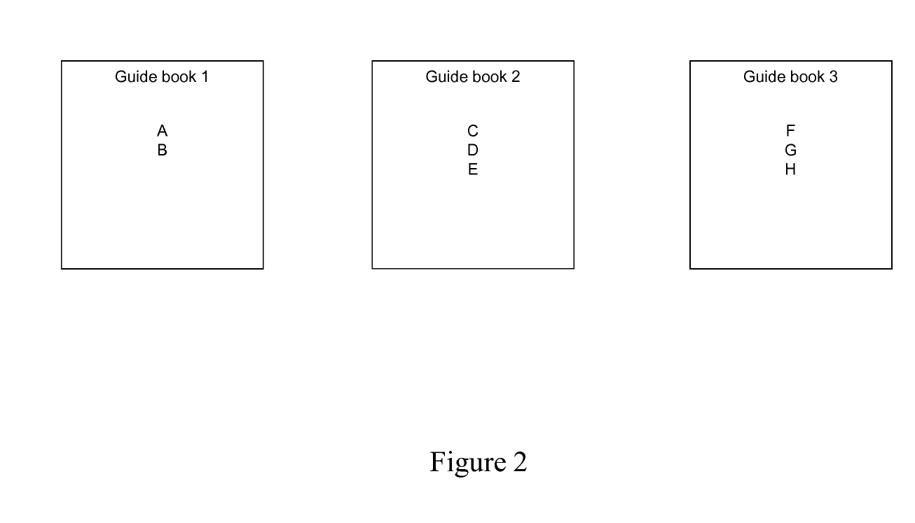

FIG. 2 is a schematic diagram illustrating a traditional approach to providing information about several topics segregated into discrete, fixed books. As shown in FIG. 2, traditionally information is published into several discrete, fixed books. In the context of guide books, information about several places may be included in one book, while information about other places of interest may be included in a second book, and information about even other places of interest may be included in a third book, and so on. In this traditional publishing scenario, three different guide books must be acquired in order to obtain the desired information on all eight of the illustrative points of interest. This makes travel from place to place and using the information in the three guide books complex, as the user must switch between the different guide books to establish all information about the locations within the user's circle of interest.

Similarly, with respect to cookbooks, a first book might include recipes on many different types of desserts, a second cookbook might contain recipes on different types of cookies, while a third recipe book might contain recipes grouped according to complete meal ideas, each of which contains a dessert recipe. If published in a traditional manner, a user of the cookbooks would have to acquire all three cookbooks to have all desired recipes pertaining to oatmeal cookies that are contained in all three books. To make comparisons between the recipes (for example to find recipes that include ingredients the user has on hand), the user must navigate through each book to identify the oatmeal cookie recipes and switch back and forth between books to select an appropriate recipe.

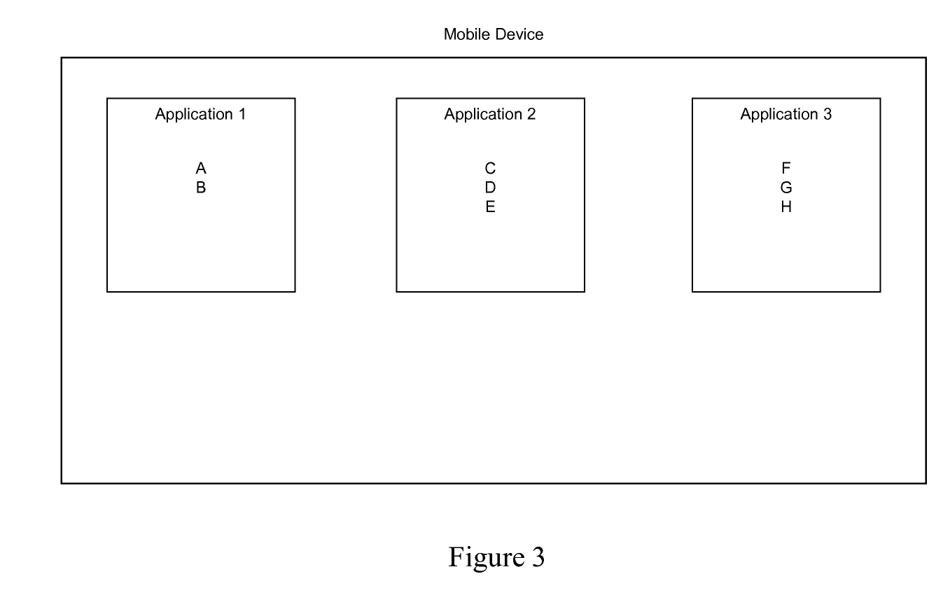

FIG. 3 is schematic diagram illustrating a traditional approach to providing information about several topics segregated into several discrete, fixed electronic books. FIG. 3 represents the direct digitalization of the guide books as separate applications loaded onto a mobile device such as a smart phone. The user has access to all the information about the eight illustrative points of interest, however, the user has to open and use the three example applications to access the totality of this information. Likewise, if the guide books were instead cookbooks, the user would still have to open each electronic cookbook and make the comparison between recipes in a similar linear-based manner.

The eight exemplary points of interest labeled A, B, C, D, E, F, G, and H in FIGS. 1-3 are traditionally documented in physical media such as guide books (FIG. 2) or more recently as separate applications (FIG. 3). In both the traditional physical media or the newer electronic media (represented by FIGS. 2 and 3), the user must switch between guides (whether physical or electronic applications), and typically peruse the guides in a page by page manner (linear reading), to gain all information about points A through to H.

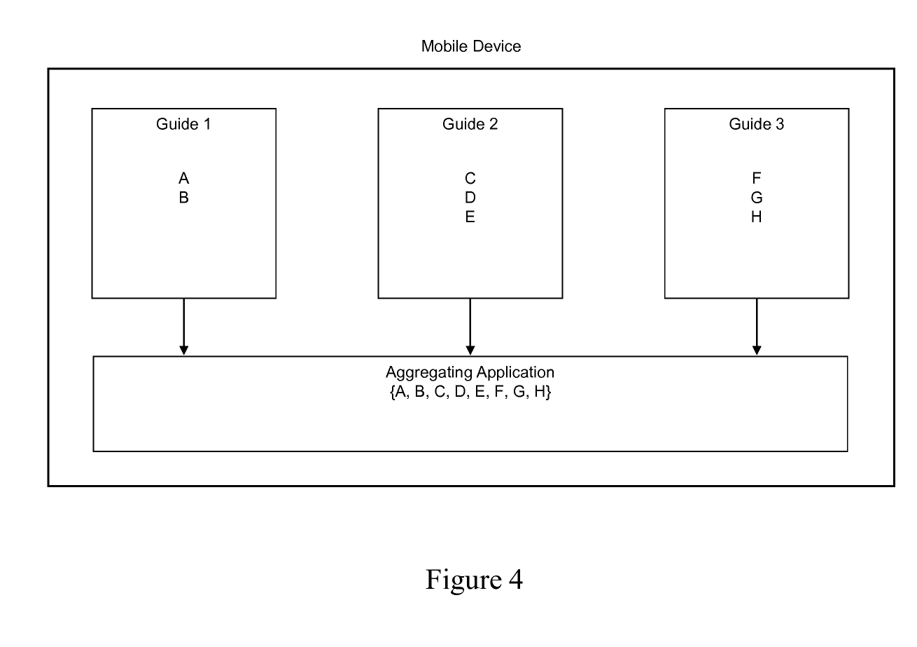

In contrast, the essence of the invention is illustrated in FIG. 4. Instead of requiring the user to view multiple guides (FIG. 3), a single application is used to aggregate the information from multiple guides residing on the mobile device and to present the information to the user as a single homogenous collection of location aware data (FIG. 4). In particular, FIG. 4 is a schematic diagram illustrating an embodiment of the present invention that uses a single application to combine location aware material from several sources. As shown in FIG. 4, a single application can be used to combine the location aware material of the three electronic guides, such that the user only uses the single aggregating application to see information about all points of interest and without regard to the original source of the location aware material.

Likewise, with respect to the cookbook analogy, the cookbooks can be retrieved in whole or part by the user electronically and portions of those cookbooks can be segregated from the original published entity and re-combined with other segments or fragments to form a new virtual publishable entity only containing, for example, the oatmeal cookie recipes. Such applications (travel guides, cookbooks, etc.) are equally applicable in using fragments of information that are not tagged with location-aware capabilities but rather are tagged in some way to facilitate identification of and re-grouping of desired fragments of information.

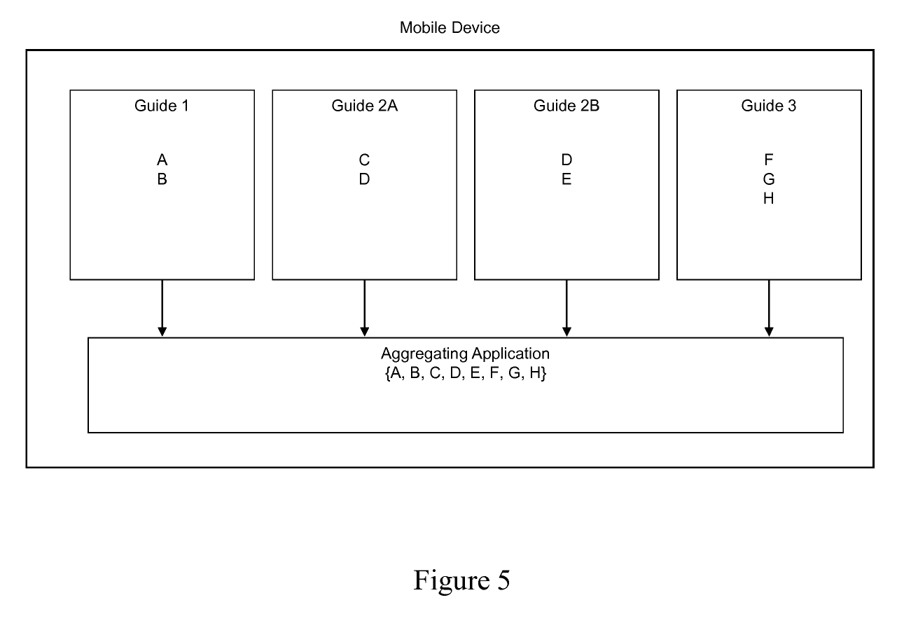

As the mobile application is able to aggregate information from multiple sources into a single superset of this information, it is also possible for the total content to be divided into different or smaller publications, such as sub-groups. FIG. 5, for example, illustrates the publisher of “guide 2” creating two different guides from the same material, with one guide (2A) having information about points C and D, and another guide (2B) that has information about points D and E. As the aggregation application creates the superset of location aware information from the source publications (guides 1, 2A, 2B and 3) information about location D can reside in multiple source publications (guides 2A and 2B) with the user only being presented with information about location D once, despite it being sourced twice from two different guides.

More particularly, FIG. 5 is a schematic diagram illustrating an embodiment of the present invention that uses a single application to combine location aware material from several sources. As shown in FIG. 5, the invention provides the ability to divide guides into multiple publications, such that the content can be published in smaller units that may be targeted to a more specific audience. Also illustrated by FIG. 5 is the ability for multiple guides to contain replicated information, such that the user is not aware of the duplication. In this way, the user only sees the results of the aggregation of the location aware data contained within the set of guides resident on the mobile device.

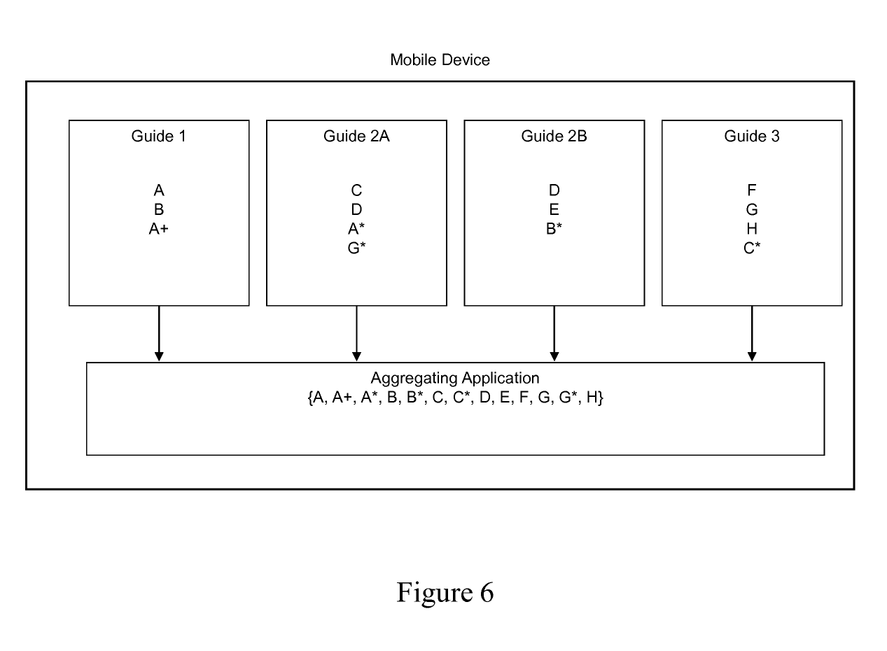

FIG. 6 illustrates the ability for one or more guides to contain different and plural location aware information data about the same location. The aggregation function of the ideal embodiment is able to identify and isolate different multimedia data about the same location such that the user is presented with the unique superset of information about the same points, regardless of the source of the data to the aggregation function of the ideal embodiment.

As shown, FIG. 6 represents the ability for the same or different guides to contain location aware information with the same location but different information such that the user is presented with the aggregated information about the same exemplary eight points of interest, but now with additional information presented about points A, B, C, and G. As shown, ‘A’, ‘A+’ and ‘A*’ represent three different pieces of information about the same point of interest A. The user is presented with the plurality of information from all guides without regard to where the information was sourced from.

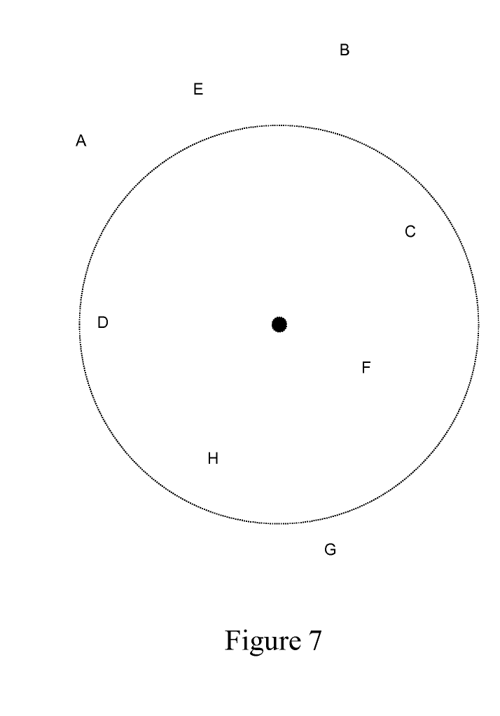

The ideal embodiment will enable the user to directly or indirectly define the radius of the circle of interest (e.g., FIG. 7). This includes, but is not limited to, the user stating to the application that some form of vehicular transportation is available, or that the user has no transport and must walk, run or crawl to transport himself or herself to a point of interest. Changing the radius to the circle of interest will either add or remove points from the aggregation function of the ideal embodiment.

FIG. 7 is a schematic diagram illustrating another feature of embodiments of the present invention, namely, setting parameters for a search to control the number of results. More particularly, as shown in FIG. 7, the circle of interest can be reduced (or enlarged) to select fewer (or more) points of interest that lie closer to (or farther from) the user. One way of selecting a desired search parameter is by distance from the user. For example, the user can set the search parameters such that only points of interest within 10 miles of the user are provided in the search results. Another way to accomplish this task is to set the search to find only points of interest that are within a certain driving time from the user's location, such as within a 10-minute drive. Even further, the search can be set to identify locations within jurisdictions that border the jurisdiction in which the user is presently located. For example, the search could be set to identify all towns and cities that share a border with the city in which the user (and consequently the user's mobile device) is currently located. Other ways of controlling the search results can also be used according to any preference setting.

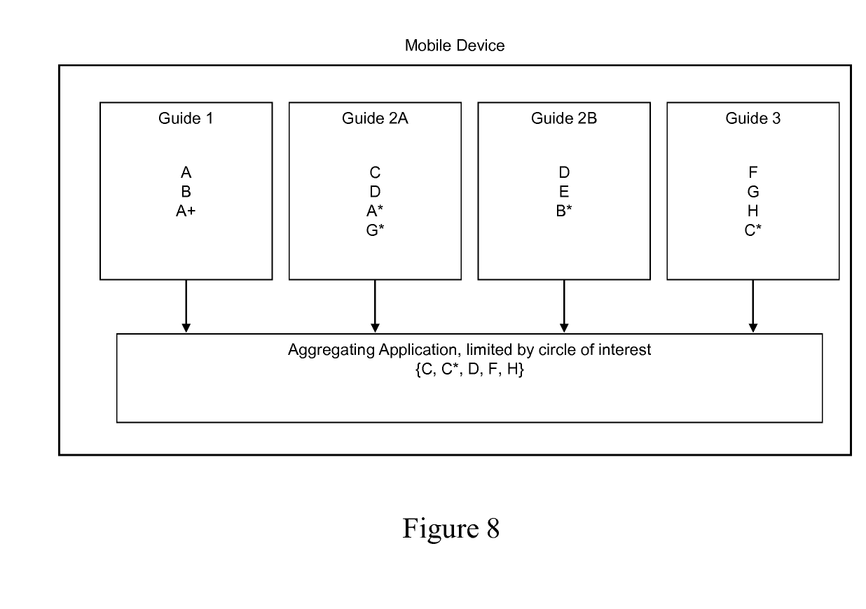

Consequently, changing the radius of the circle of interest (or other parameter change) will change the results of the aggregation function of the ideal embodiment and consequently change the points of interest presented to the user, regardless of the original source of the location aware data (e.g., FIG. 8).

FIG. 8 is a schematic diagram representing how information can be collected and aggregated using embodiments of the invention to reduce the amount of information collected and aggregate the information from one or more sources in part or in whole. For example, FIG. 8 represents the reduction of information presented to the user resulting from the reduced circle of interest illustrated in FIG. 7. More particularly, the search parameters are set in a manner that allows for collection of a reduced amount of information. Here, the information is reduced according to a maximum distance the points of interest are located from the user. All information associated with the points of interest that fall within the selected radial distance from the user are collected. The information in this embodiment is collected from several different sources, wherein the sources contain bit(s) of the desired information and may contain the same information in the several sources and/or may contain additional information in one source or another about the same point of interest. According to embodiments of the invention, only the relevant information (i.e., information from the points of interest within the selected distance) is collected and this information is extracted from the different sources and compiled into a format that the user can navigate as a whole. Alternatively, the entire original published version of the information can be collected as a discrete unit, then the desired information (data relating to the points of interest within a certain distance of the user's mobile device) can be extracted from the original source and aggregated (or re-grouped) with other bits of relevant information from other sources. A virtual book is created from the several parts or bits of information from the several published sources and is presented to and navigated by the user as if it were a single source, without the user knowing the information is actually aggregated from several sources, and possibly several different publishers.

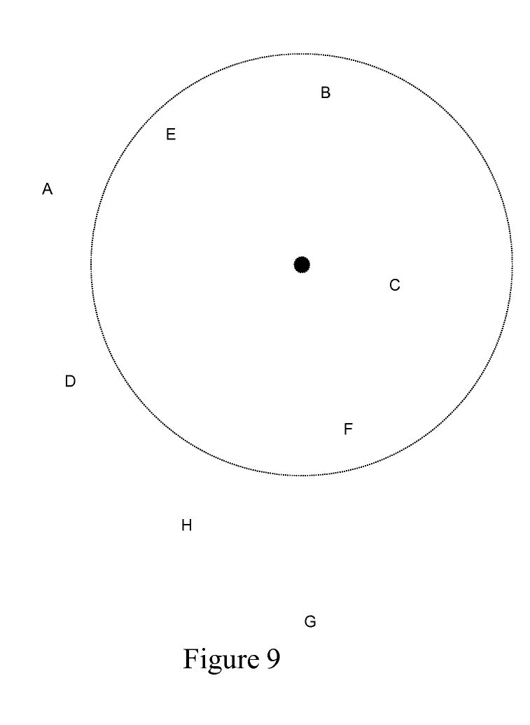

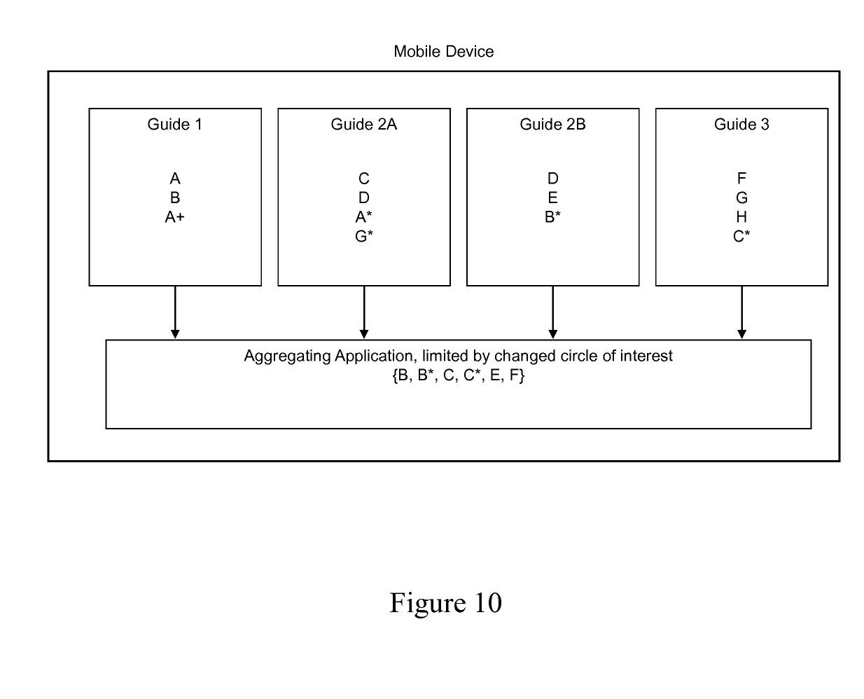

The ideal embodiment will continuously establish the user's location (FIG. 9) and recalculate the aggregation function's results (FIG. 10) to display information about the points of interest within the user's circle of interest regardless of the original source of the location aware data (FIG. 10).

FIG. 9 is a schematic diagram showing how information is collected when the user changes location and the distance parameter remains the same as in FIG. 8. As shown in FIG. 9, a change in location of the user may result in a corresponding change in the points of interest that lie within the circle of interest. If the circle of interest otherwise remains the same, for example the selected distance between the user and the points of interest remains constant, and the user changes location, some of the points of interest may no longer fall within the circle of interest and other points of interest may now be included within the scope of the search.

FIG. 10 is a schematic diagram showing how information is collected when the user changes location and the distance parameter remains the same as in FIG. 9. More particularly, information from four publications is available for the several different points of interest shown, namely, points of interest A, B, C, D, E, F, G, and H. In a first publication, referred to as Guide 1 in FIG. 10, information A, A+, and B are available to a user. Information A and A+ comprise information about point of interest A and can be completely different content from one another or one can be a subset of content from the other. For example, A and A+ can be two different pieces of information about point of interest A. Likewise, information B relates to point of interest B. Although all information A, A+, and B is available to the user, only information B will be presented to the user because information A and A+ relate to site A, which is not within the desired circle of interest and is thus not relevant to the user at this particular time. In a second publication, referred to as Guide 2A in FIG. 10, information C, D, A*, and G* are available to the user. Information C, D, A*, and G* correspond respectively with points of interest C, D, A, and G. A* and G* in this example are respectively different pieces of information about sites A and G. Although information C, D, A*, and G* are available, only information C will be presented to the user, as sites D, A, and G are no longer within the user's circle of interest. In a third publication, referred to as Guide 2B in FIG. 10, bits of information D, E, and B* relate respectively to points of interest D, E, and B, and B* is a different piece of information than data B. Although information D, E, and B* are available, only information E and B* will be presented to the user, as site D is no longer within the user's circle of interest. In a fourth publication, Guide 3 in FIG. 10, pieces of information F, G, H and C* correspond with sites F, G, H and C respectively, and C* is a portion of information or different information than that which is contained in information C. Information G, which corresponds with point of interest G which falls outside of the user's circle of interest, will not be presented to the user at this time; information H, which corresponds with point of interest H which falls outside of the user's circle of interest, also will not be presented to the user at this time.

As shown in FIG. 10, the user may change physical locations and his device will respond by locating all sites within the selected circle of interest. For example, as shown in FIG. 7, the user was at a location that had sites of interest C, D, F, and H within his circle of interest. Upon changing location to that shown in FIG. 9, the user now has sites B, C, E, and F within his circle of interest. The user's device will respond accordingly by providing information to the user relating to this new set of points of interest. The information about sites B, C, E, and F that is available is thus aggregated and provided to the user. In particular, pieces of information B, B*, C, C*, E, and F (FIG. 10) will be made available to the user without the user knowing the pieces of information originated from four separate publications and potentially separate publisher sources. Compared with traditional methods of traveling, a user in this situation will have a much easier time of navigating through the information because irrelevant information has been filtered out before presentation of the relevant information to the user.

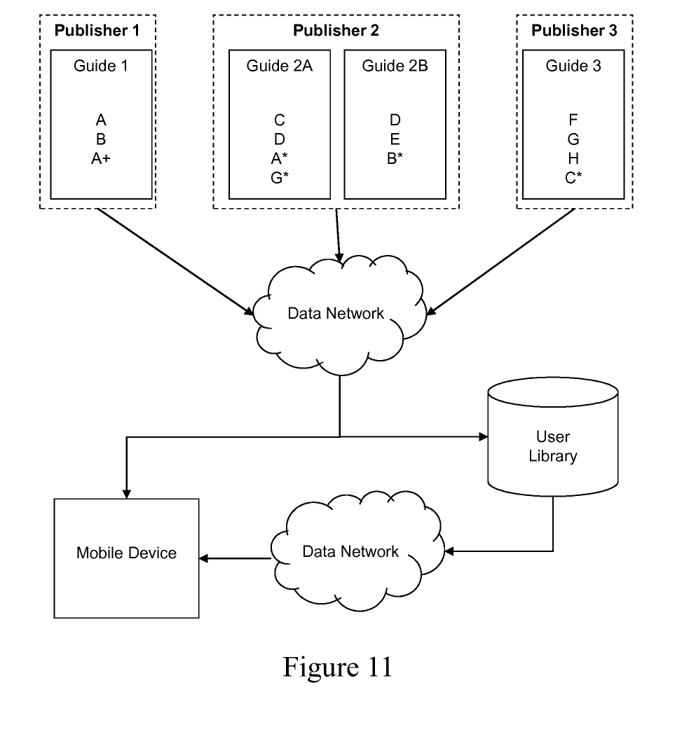

FIG. 11 is a schematic diagram showing embodiments of the invention involving acquisition of location aware multimedia content from multiple publishers and optionally storage of the content on a computer-readable storage medium. As shown in FIG. 11, data can be obtained from one or more different publisher sources, as well as different publications from those sources. For example, a mobile device user can acquire available location aware multimedia content (A, B, A+, C, D, A*, G*, D, E, B*, F, G, H, and C*) from three example publishers (Publishers 1, 2, and 3), with the content being stored in the user's library on some computer system, and/or the content being downloaded directly to a storage medium of the mobile device, and/or the content being made available to the mobile device from the remote publisher or user library by way of data network, or a mixture of the three methods of supplying location aware multimedia content to the mobile device.

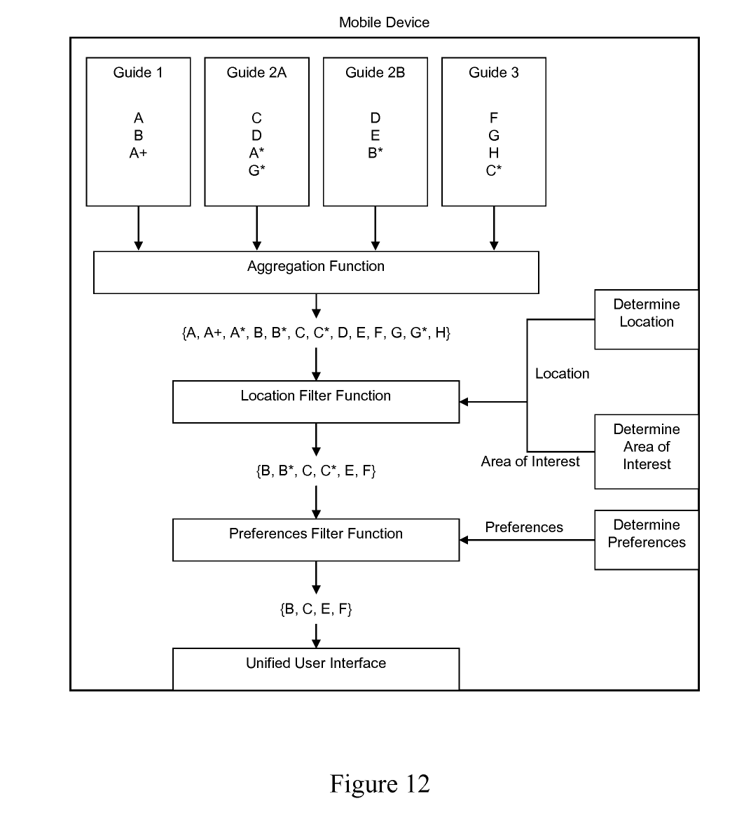

FIG. 12 is a schematic diagram showing embodiments of the invention that aggregate location-aware multimedia content, filter the set of content by mobile device location and user area of interest, further filter that set by user preferences, and present content to a user. As provided in FIG. 12, the totality of the available published content exemplified in FIG. 11 is available as stored media on the mobile device. The data may also be stored on another device operably connected with the mobile device to achieve the same result. An aggregation application is then used so that all information A, A+, A*, B, B*, C, C*, D, E, F, G, G*, and H is processed by way of software and corresponding hardware to aggregate the location-aware information as A, A+, A*, B, B*, C, C*, D, E, F, G, G*, and H. As shown, any overlap in data (for example, data set D, which is shown in both Publications 2A and 2B) can optionally exist in the aggregate or set as a single data set D. This aggregated set is then filtered by the device's location and user determined area of interest. Here, the resultant first filtered set comprises information B, B*, C, C*, E, and F due to the device's location (see FIG. 9) and/or the area of interest not encompassing corresponding sites A, D, F, G, and H at that time. This location/area-based filtered set is then optionally additionally filtered by user preference(s). Here, the resultant second filtered set comprises only information B, C, E, and F, due to data B* and C* having been filtered out by certain preference parameter settings. This aggregated and filtered multimedia content, B, C, E, and F, optionally additionally stored on a storage medium as a discrete set, is capable of being viewed by a user of the mobile device through a unified user interface as a virtual set of data or actual set of data.

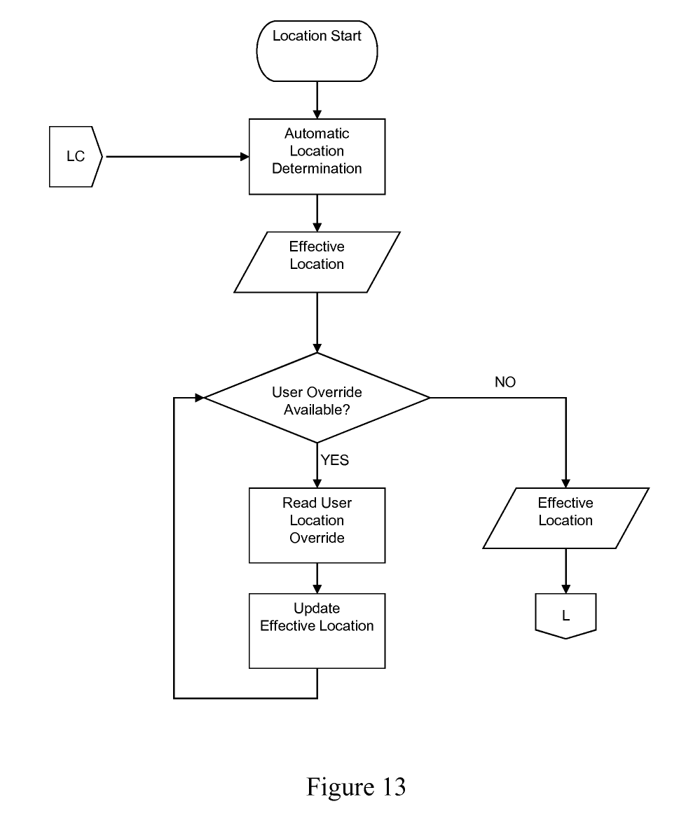

FIG. 13 is a flowchart showing a representative process that may be used with embodiments of the invention for determining a location to use for content filtering. According to FIG. 13, a location of the user and/or mobile device can be determined automatically to identify an effective location of the device. Optionally, this feature can be subject to manual override by the user of the device, if desired to base the collection of data on a different location.

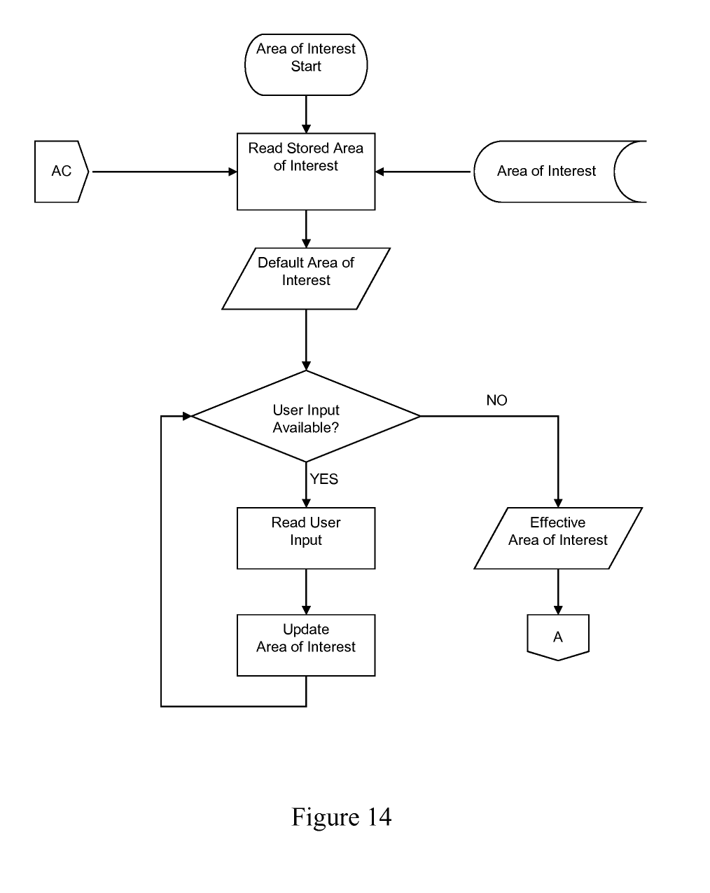

FIG. 14 is a flowchart showing a representative process that may be used with embodiments of the invention for determining the area of interest to use for content filtering. In this example, a default area of interest optionally can be stored on or accessible to the device and referenced by the applications of the invention, optionally subject to user override, as appropriate, to result an effective area of interest to be used as a parameter for content filtering.

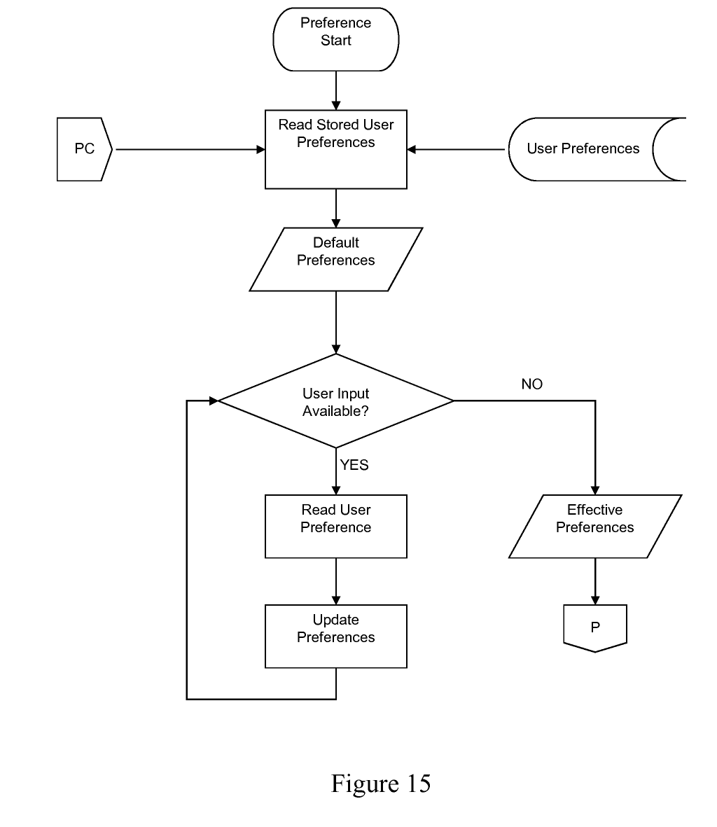

FIG. 15 is a flowchart showing a representative process that may be used with embodiments of the invention for determining user preference(s) for content filtering. More particularly, FIG. 15 shows an example of integrating user preference parameters into applications of the invention. For example, default preferences (e.g., user preferences) can optionally be stored on or accessible to the device and referenced by applications of the invention during use of the mobile device, optionally subject to override by a user. Effective preferences are then produced for use in content filtering.

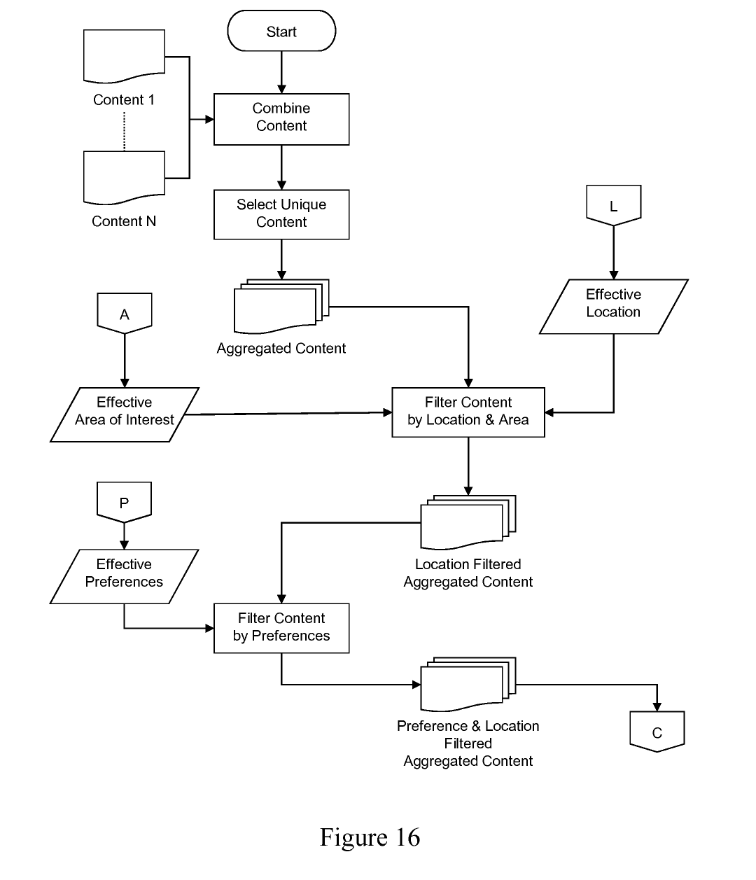

FIG. 16 is a flowchart showing a representative process that may be used with embodiments of the invention for aggregating all multimedia content, filtering by location and area of interest, and further filtering by user preference to produce a manageable set of content. As exemplified in FIG. 16, one way of identifying, collecting, aggregating, and filtering data for a user can be performed by collecting and combining the totality of the location aware multimedia content into the aggregated content. This grouping of information can then be filtered by the effective location and effective area of interest to produce the location filtered aggregated content. This filtered content can then be filtered by the user's effective preferences to produce the preference and location filtered aggregated multimedia content.

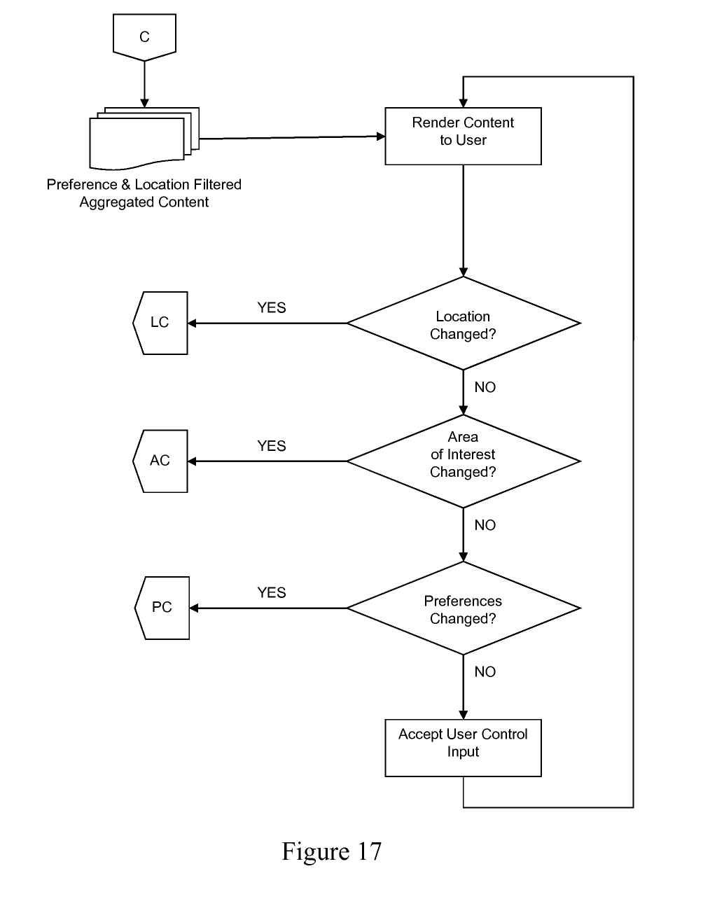

FIG. 17 is a flowchart showing a representative process that may be used with embodiments of the invention for presenting a preference and/or location filtered aggregate. As shown, identified, collected, aggregated, and filtered (which can be performed in any order) information can be rendered (displayed, played, etc.) to the user. More specifically, FIG. 17 shows an example of how one or more of the processes shown in FIGS. 13-16 can be combined (not all must be used in any one particular application) to present a manageable set of relevant multimedia content to a user. Subsequently, should any of the location, area of interest or preferences change, the control flow loops back the appropriate point to eventually cause an updated preference and location filtered aggregation multimedia content. If none of the location, area of interest or user preferences have changed, the user is able to control the application through the user interface resulting in the preference and location filtered aggregated multimedia content being re-rendered as appropriately to the user.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. It is intended that the specification and examples be considered as exemplary in nature and that variations that do not depart from the essence of the invention are intended to be within the scope of the invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown. It is therefore evident that the particular illustrative embodiments disclosed above may be altered or modified and all such variations are considered within the scope and spirit of the present invention. While systems, devices, and methods are described in terms of “having,” “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined in this application. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A system for aggregating information into a publishable entity comprising:
one or more storage media comprising discrete groupings or sub-groupings of electronic content composed of one or more multimedia fragments (e-fragments) with location-aware tags and capable of being divisible from the discrete groupings or sub-groupings;
a network operably connecting the e-fragment storage media with a mobile device for enabling communication between the mobile device and the e-fragments;
a mobile device with a storage medium and operably configured with a processor, software, and hardware for a) determining its location, b) communicating the location to the location-aware e-fragments, c) selecting and receiving data as one or more of the discrete groupings, discrete sub-groupings, or e-fragments, d) storing the data on the mobile device storage medium, e) further selecting e-fragments from the data and aggregating the selected e-fragments into a publishable entity, and f) presenting the publishable entity to a user of the mobile device as a virtual unified source.

2. A method for providing location-aware data to a user comprising:
identifying a location of a user's mobile device;
identifying sites located within a selected distance of the location of the mobile device;
identifying site-related information relating to the sites and contained in one or more location-aware multimedia fragments of one or more electronically published entity, wherein each multimedia fragment is configured in one common data format;
collecting the published entities and multimedia fragments thereof;
selecting and segregating from the published entities only the site-related information;
aggregating only the selected and segregated site-related information into a compilation of site-related multimedia fragments; and
presenting the compilation of site-related multimedia fragments as a virtual discrete publishable entity for display on the mobile device using a unified user interface.

3. The method of claim 2 further comprising identifying the sites and the site-related information according to additional user personal preference parameters.

4. The method of claim 2, wherein the collecting of the site-related multimedia fragments for presentation on the mobile device further comprises storing all or part of the published entities locally on the mobile device for off-line presentation of the information.

5. The method of claim 2, wherein the identifying and collecting are performed by way of a direct or indirect data network.

6. The method of claim 2, wherein:
the collecting further comprises storing all or part of the published entities locally on the mobile device for off-line presentation of the information;
the identifying and collecting are performed by way of a direct or indirect data network;
the mobile device is capable of autonomously determining its exact or approximate location by way of a positioning system.

7. The method of claim 6, wherein the positioning system is global positioning.

8. The method of claim 6, wherein the positioning system is cellular positioning.

9. The method of claim 2, wherein:
the collecting further comprises storing all or part of the published entities locally on the mobile device for off-line presentation of the information;
the identifying and collecting are performed by way of a direct or indirect data network;
the mobile device is capable of determining its exact or approximate location by way of user input or being operably connected with any system capable of providing position data.

10. A method of publishing electronic content comprising publishing, on a computer-based network, a set of multiple electronic multimedia fragments as a single compilation, wherein the compilation is operably configured for dissection into subsets comprising one or more of the multimedia fragments.

11. The method of claim 10, wherein the compilation is a travel guide and the subsets are micro travel guides.

12. The method of claim 10, wherein the compilation is location aware promotional material and the subsets are micro location aware promotional materials.

13. The method of claim 10, wherein each multimedia fragment is configured in one common data format for providing for electronic re-grouping of the multimedia fragments into a virtual discrete publishable entity.

14. A device operably configured to perform the method of claim 2.

15. The device according to claim 14, which is a hand-held mobile device comprising hardware and software for executing the data-providing method of claim 2.

16. A location-aware multimedia fragment stored on a machine-readable medium formatted for collection and aggregation with other common-format location-aware multimedia fragments into a publishable entity composed of a set of the collected and aggregated fragments.
